(19) United States
(12) Patent Application Publication
(10) Pub. No.: US 2007/0029146 A1
(43) Pub. Date: Feb. 8, 2007

(54) Rear disc brake plate assembling device

(76) Inventor: Wen-Kuo Huang, Longtan Township (TW)

Correspondence Address: TROXELL LAW OFFICE PLLC, SUITE 1404, 5205 LEESBURG PIKE, FALLS CHURCH, VA, 22041, US

(21) Appl. No.: 11/198,270

(22) Filed: Aug. 8, 2005

(51) Int. Cl. B60T 1/06

(52) U.S. Cl. 188/218 XL; 188/18 A

(57) ABSTRACT

A rear disc brake plate is composed of a ventilation disc, a brake drum, and a fixing disc, wherein upon screwing the ventilation disc, the brake drum, and the fixing disc, a plurality of screws can be used to configure them into the rear disc brake plate which is light in weight and has an extremely high sharing property. The rear disc brake plate is a device whose structures can be assembled separately; therefore, when any structure is worn out, it can be replaced independently, thereby keeping pleasing and environmental benign and saving resource.

### BACKGROUND OF THE INVENTION

(a) Field of the Invention

The present invention relates to a rear disc brake plate assembling device, and more particularly to an assembling device stand wherein a heat dissipating passageway passing through a disc surface is installed in a ventilation disc, and a latching member and screw holes are located at a side to provide for connection and latching.

(b) Description of the Prior Art

Referring to FIG. 1, in a conventional rear disc brake plate A, fixing holes A2 are located at a side of a shaft hole A1, and an inner brake drum A3 is located beside the fixing holes A2 for locking a rotation of a Wheel tire. A disc surface A4 of the brake is extended from the side of the inner brake drum A3 for stopping a rotation of a car wheel tire when the brake system activates a disk lining to clip on and stop the rotation of the disc surface A4. In addition, as the conventional disc brake plate A is made by integrally forming in a whole unit, any one of the structure cannot be replaced when the inner brake drum A3 and the disc surface A4 are consumed. Therefore, it will cause a waste to an environmental resource when the conventional disc brake plate A is thrown way after using, and also increase a lot of concern to the environmental pollution.

Accordingly, how to provide a rear disc brake plate which can save resource and is provided with a better sharing property, is a technical issue which needs to be solved by the inventor.

### SUMMARY OF THE INVENTION

The present invention is to provide a rear disc brake plate assembling device wherein a heat dissipating passageway passing through a disc surface is installed in a ventilation disc, and a latching member and screw holes are located at a side to provide for connection and latching.

An inner brake drum surface is located in the inner brake drum for locking a wheel tire, and screw holes corresponding to a fixing disc are located at a side of the inner drum surface.

Upon screwing the ventilation disc, the brake drum, and the fixing disc, a plurality of screws can be used to configure the rear disc brake plate into a structure which is light in weight and has an extremely high sharing property.

In addition, the rear disc brake plate is a device whose structures can be assembled separately; therefore, when any structure is worn out, it can be replaced independently, thereby keeping pleasing and environmental benign and saving resource.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional application.

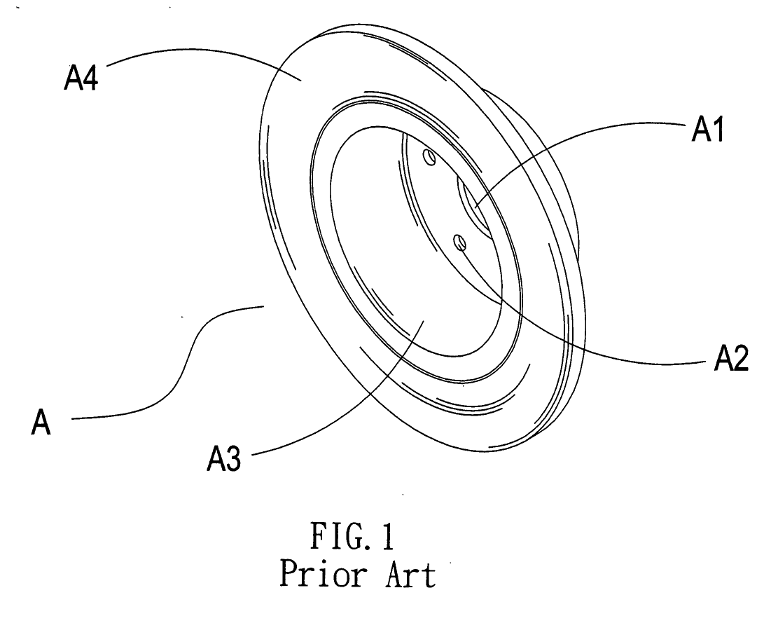

FIG. 2 shows a perspective view of the present invention.

FIG. 3 shows a perspective view of compartments of the present invention.

FIG. 4 shows a perspective view upon assembling the present invention.

FIG. 5 shows another perspective view upon assembling the present invention.

FIG. 6 shows a schematic view of an implementation of the present invention.

### DETAILED DESCRIPTION OF THE PREFERRED EMBODIMENTS

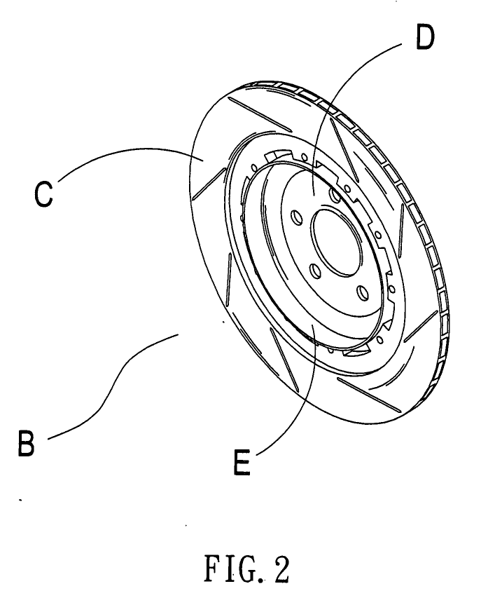

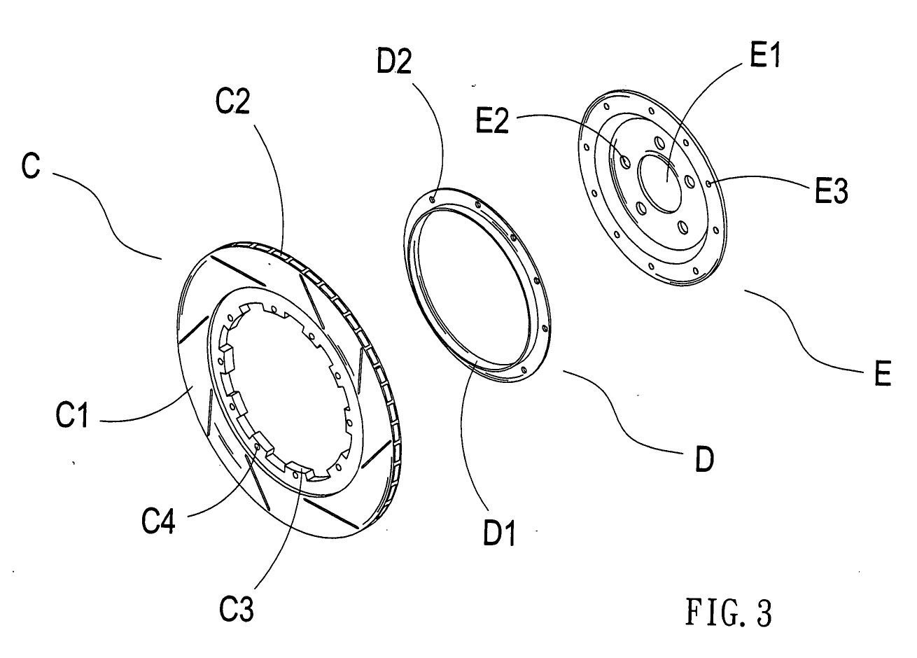

Referring to FIG. 2 and FIG. 3, an improved structure of a rear disc brake plate assembling device is constituted by a ventilation disc C, a brake drum D, and a fixing disc E, wherein a plurality of heat dissipating passageways C2 passing through a disc surface C1 are installed in the ventilation disc C, and a latching member C3 and screw holes C4 are located at a side to provide for connection and latching; an inner brake drum surface D1 is located in the brake drum D for locking a wheel tire, and screw holes D2 corresponding to the fixing disc E are located at a side of the inner drum surface D1; a fixing shaft hole E1 is located at a center of the fixing disc E, fixing holes E2 for screwing are located at a side to the fixing shaft hole E1, and corresponding screwing holes E3 are located at an outer side of the fixing shaft hole E1.

When heat energy is generated by the rear disc brake plate B, the heat energy can be expelled out by a plurality of heat dissipating passageways C2 surrounding the side, so as to increase a heat dissipating efficiency of the rear disc brake plate when the rear disc brake plate is stopping a rotation of a car wheel tire.

Upon screwing the ventilation disc C, the brake drum D, and the fixing disc E, a plurality of screws can be used to configure the rear disc brake plate B into a structure which is light in weight and has an extremely high sharing. property. In addition, the ventilation disc C and the fixing disc E are made by an alloy material which is light in weight and is not easy to be worn out, such that an efficiency in utilization and a lifetime can be increased when configuring the rear disc brake plate into a whole unit.

Moreover, the rear disc brake plate B is a device whose structures can be assembled separately; therefore, when any structure is worn out, it can be replaced independently, thereby keeping pleasing and environmental benign and saving resource.

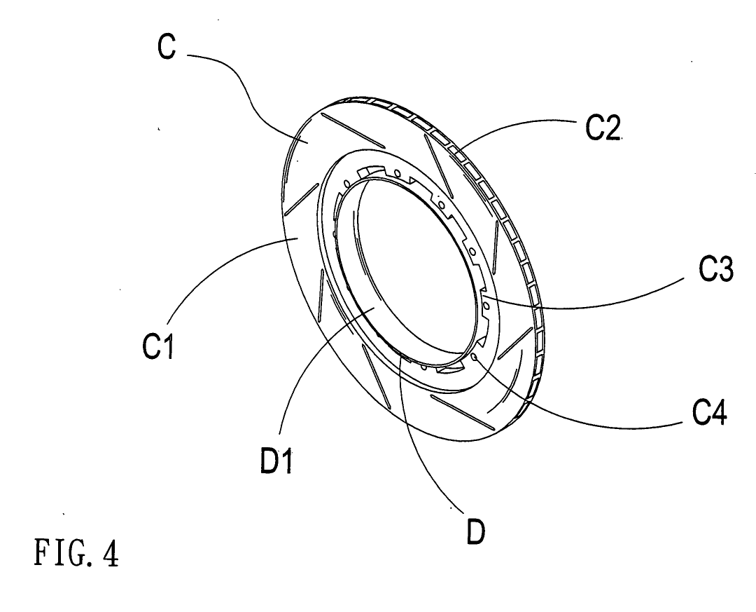

Referring to FIG. 3 and FIG. 4, it shows an implementation method of the present invention, wherein the plurality of heat dissipating passageways C2 passing through the disc surface C1 are installed in the ventilation disc C, and the latching member C3 and the screw holes C4 are located at a side to provide for connection and latching; the inner brake drum surface D1 is located in the brake drum D for locking a wheel tire, and the corresponding screw holes D2 are located at a side of the inner drum surface D1.

Upon installing the brake drum D and the ventilation disc C, a plurality of screws can be used to configure them into a whole unit. In addition, when heat energy is generated by the rear disc brake plate B, the heat energy can be expelled out by the plurality of heat dissipating passageways C2 surrounding the side, so as to increase a heat dissipating efficiency of the rear disc brake plate B when the rear disc brake plate B is stopping a rotation of a car wheel tire.

Furthermore, the ventilation disc C and the brake drum D are device structure with an extremely high sharing property; therefore, when the rear disc brake plate B is applied to wheel structures of different specification, a milling machine can be used to adjust a hole size of the ventilation disc C and the brake drum D, thereby facilitating a structure with an extremely high sharing property.

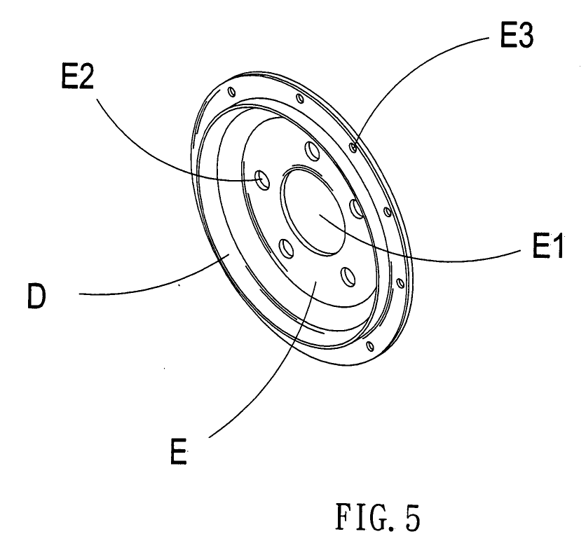

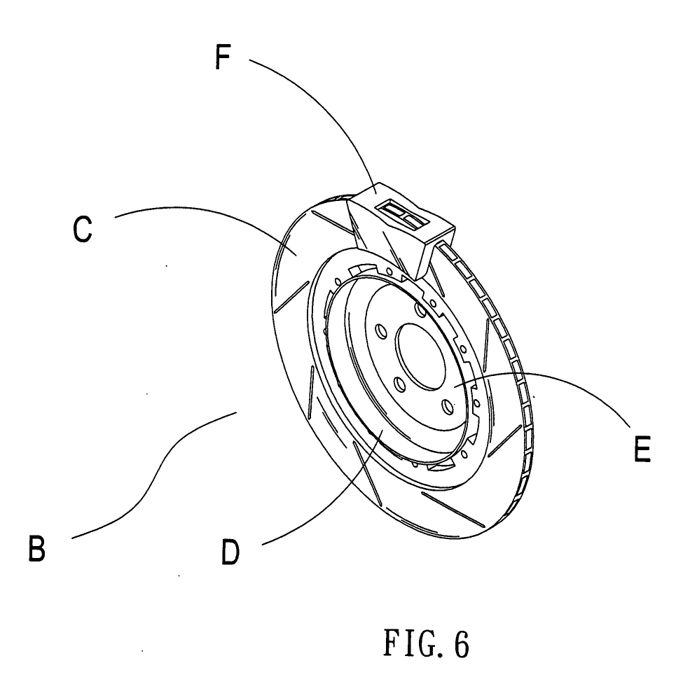

Referring to FIG. 5 and FIG. 6, the fixing shaft hole E1 is located at the center of the fixing disc E, the fixing holes E2 for screwing are located at a side to the fixing shaft hole E1, and the corresponding screwing holes E3 are located at an outer side of the fixing shaft hole E1. Upon installing the fixing disc E and the brake drum D, a plurality of screws can be used to install them into a whole unit, so as to accomplish a final assembling to the rear disc brake plate B.

The ventilation disc C and the fixing disc E are made by an alloy material which is light in weight and is not easy to be worn out, such that an efficiency in utilization and a lifetime can be increased when the rear disc brake plate B is locking and stopping a rotation of the ventilation disc C. In addition, the ventilation disc C, the brake drum D, and the fixing disc E are a device whose structures can be assembled separately; therefore, when any structure is worn out, it can be replaced independently, thereby keeping pleasing and environmental benign and saving resource.

To further manifest the advancement and practicability of the present invention, the present invention is compared with a conventional application as follow:

Shortcomings of a conventional application
(1) The heat dissipating is inferior, thereby affecting a efficiency in utilization.
(2) The worn-out structure cannot be replaced independently.
(3) The application is heavy and is not environmental benign nor can save resource.

Advantages of the present invention
(1) It is light in weight and has a sharing property.
(2) It is provided with a good heat dissipating efficiency.
(3) The worn-out structure can be replaced independently.
(4) It is environmental benign and can save resource, thereby reducing damage to the environment.
(5) It has an advancement and practicability.
(6) It can promote an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A rear disc brake plate assembling device comprising a ventilation disc, a brake drum, and a fixing disc, wherein upon screwing the ventilation disc, the brake drum, and the fixing disc, a plurality of screws can be used to configure them into a rear disc brake plate which is light in weight and has an extremely high sharing property; a plurality of heat dissipating passageways passing through a disc surface being installed in the ventilation disc, a latching member and screw holes for providing latching and connection being located at a side, an inner drum for locking a wheel tire being located in the brake drum, and screw holes corresponding to the fixing disc being located at a side of the inner drum surface; the rear disc brake plate being a device whose structures can be assembled separately, so as to replace any structure independently when it is worn out, thereby keeping pleasing and environmental benign and saving resource.
